(19) United States
(12) Patent Application Publication
(10) Pub. No.: US 2008/0032570 A1
(43) Pub. Date: Feb. 7, 2008

(54) Output terminal connection structure for vehicle generator capable of generating high and low voltages

(75) Inventors: Toshiki Hitomi, Nisshin-shi (JP); Shigenobu Nakamura, Anjo-shi (JP)

Correspondence Address: OLIFF & BERRIDGE, PLC, P.O. BOX 320850, ALEXANDRIA, VA, 22320-4850, US

(73) Assignee: DENSO CORPORATION, KARIYA-CITY (JP)

(21) Appl. No.: 11/822,670

(22) Filed: Jul. 9, 2007

(30) Foreign Application Priority Data
Aug. 7, 2006 (JP) 2006-214631

(51) Int. Cl. H01R 11/11

(52) U.S. Cl. 439/883

(57) ABSTRACT

The output terminal connection structure for a vehicle generator capable of generating a high voltage and a low voltage includes a high voltage output terminal provided in the vehicle generator, a high voltage lead terminal to be connected to the high voltage output terminal, a low voltage output terminal provided in the vehicle generator, and a low voltage lead terminal to be connected to the low voltage output terminal. At least one of the high voltage output terminal, the high voltage lead terminal, the low voltage output terminal, and the low voltage lead terminal is formed in such a shape or a structure that the low voltage lead terminal can be prevented from being connected to the high voltage output terminal.

### CROSS-REFERENCE TO RELATED APPLICATION

This application is related to Japanese Patent Application No. 2006-214631 filed on Aug. 7, 2006, the contents of which are hereby incorporated by reference.

### BACKGROUND OF THE INVENTION

1. Field of the Invention

The present invention relates to an output terminal connection structure for a vehicle generator generating high and low voltages.

2. Description of Related Art

Recent vehicles have many large electrical loads mounted thereon, such as an electric power steering and an electric compressor. Accordingly, the trend is toward providing them with a high voltage power supply system that has an advantage in reducing the sizes and increasing the efficiencies of apparatuses for generating and supplying electrical power to the electrical loads. For example, if a voltage of 100V is available from the power supply system, it is possible to mount home electric appliances on a vehicle as they are. However, on the other hand, for filament loads such as vehicle headlights, and for DC devices using a commutator such as a windshield wiper and a starter, it is desirable to continue using a conventional low voltage (14V, for example) power supply system, because the high voltage power supply system is not suitable to them for the reason that it poses problems of shorting their lives or increasing sparks. To meet both of these conflicting requirements, it is necessary to mount both a low voltage generator and a high voltage generator, or to produce a low voltage by use of a stepdown DC-DC converter in a case where only a high voltage generator is mounted on a vehicle. Since production cost and installation space increase in either case of mounting low-voltage and high-voltage generators on a vehicle, or mounting a high voltage generator and a stepdown DC-DC converter on a vehicle, it is proposed to generate both a high voltage and a low voltage from a single generator having different windings as disclosed, for example, in Japanese Patent Application Laid-open No. 6-105512, and Japanese Patent No. 2946592.

However, generating a high voltage and a low voltage by a single generator has a problem in that if a low voltage lead terminal is connected by mistake to a high voltage output terminal of the generator, low voltage devices that should be connected to a low voltage output terminal of the generator through the low voltage lead terminal may be broken due to shortage of withstand voltage, or short-lived due to excessive temperature rise.

### SUMMARY OF THE INVENTION

The present invention provides an output terminal connection structure for a vehicle generator capable of generating a high voltage and a low voltage comprising:

a high voltage output terminal provided in the vehicle generator;

a high voltage lead terminal to be connected to the high voltage output terminal;

a low voltage output terminal provided in the vehicle generator; and

a low voltage lead terminal to be connected to the low voltage output terminal;

wherein at least one of the high voltage output terminal, the high voltage lead terminal, the low voltage output terminal, and the low voltage lead terminal is formed in such a shape or a structure that the low voltage lead terminal can be prevented from being connected to the high voltage output terminal.

According to the present invention, it becomes possible to prevent misconnection without fail between the low voltage lead terminal and the high voltage output terminal in a vehicle generator capable of generating high and low voltages, to thereby prevent low voltage devices from being broken due to shortage of withstand voltage, or short-lived due to excessive temperature rise by misconnection.

The low voltage output terminal, and the low voltage lead terminal may be respectively smaller in outer dimension than the high voltage output terminal, and the high voltage lead terminal.

The low voltage terminal may be provided with a projection, the projection interfering with a bearing surface of the high voltage output terminal provided for bearing the high voltage lead terminal, to thereby prevent misconnection between the low voltage lead terminal and the high voltage output terminal, and not interfering with a bearing surface of the low voltage output terminal provided for bearing the low voltage lead terminal to allow connection between the low voltage lead terminal and the low voltage output terminal.

A smallest width of the bearing surface of the low voltage output terminal across a center thereof may be smaller than a smallest width of the bearing surface of the high voltage output terminal across a center thereof.

The bearing surface of the low voltage output terminal may be formed with a recess receiving therein the projection when the low voltage lead terminal is connected to the low voltage output terminal.

The low voltage lead terminal may be provided with a projection, the high voltage output terminal may be partially covered by an insulating member having a bearing surface for bearing the high voltage lead terminal, and the low voltage output terminal may be partially covered by an insulating member having a bearing surface for bearing the low voltage lead terminal, the projection interfering with the bearing surface of the high voltage output terminal, to thereby prevent misconnection between the low voltage lead terminal and the high voltage output terminal, and not interfering with the bearing surface of the low voltage output terminal to allow connection between the low voltage lead terminal and the low voltage output terminal.

A smallest width of the bearing surface of the low voltage output terminal across a center thereof may be smaller than a smallest width of the bearing surface of the high voltage output terminal across a center thereof.

The bearing surface of the low voltage output terminal may be formed with a recess receiving therein the projection when the low voltage lead terminal is connected to the low voltage output terminal.

The high voltage output terminal may be partially covered by a tubular insulating member which is formed with a first turn-prevention recess at a circumferential end thereof allowing a part of the high voltage lead terminal to be housed therein when the high voltage lead terminal is connected to the high voltage output terminal, and the low voltage output terminal may be partially covered by a tubular insulating member which is formed with a second turn-prevention recess at a circumferential end thereof allowing a part of the low voltage lead terminal to be housed therein when the low voltage lead terminal is connected to the low voltage output terminal, a circumferential width of the first turn-prevention recess and a width of the part of the high voltage lead terminal being smaller than a circumferential width of the second turn-prevention recess and a width of the part of the low voltage lead terminal.

Other advantages and features of the invention will become apparent from the following description including the drawings and claims.

### BRIEF DESCRIPTION OF THE DRAWINGS

In the accompanying drawings:

FIGS. 1A and 1B are diagrams showing an output terminal connection structure for a vehicle generator capable of generating high and low voltages according to a first embodiment of the invention;

FIGS. 2A and 2B are diagrams showing an output terminal connection structure for a vehicle generator capable of generating high and low voltages according to a second embodiment of the invention;

FIG. 3 is a diagram showing an output terminal connection structure for a vehicle generator capable of generating high and low voltages according to a variant of the second embodiment of the invention;

FIGS. 4A and 4B are diagrams showing an output terminal connection structure for a vehicle generator capable of generating high and low voltages according to a third embodiment of the invention;

FIG. 5 is a diagram showing an output terminal connection structure for a vehicle generator capable of generating high and low voltages according to a variant of the third embodiment of the invention; and

FIGS. 6A and 6B are diagrams showing an output terminal connection structure for a vehicle generator capable of generating high and low voltages according to a fourth embodiment of the invention.

### PREFERRED EMBODIMENTS OF THE INVENTION

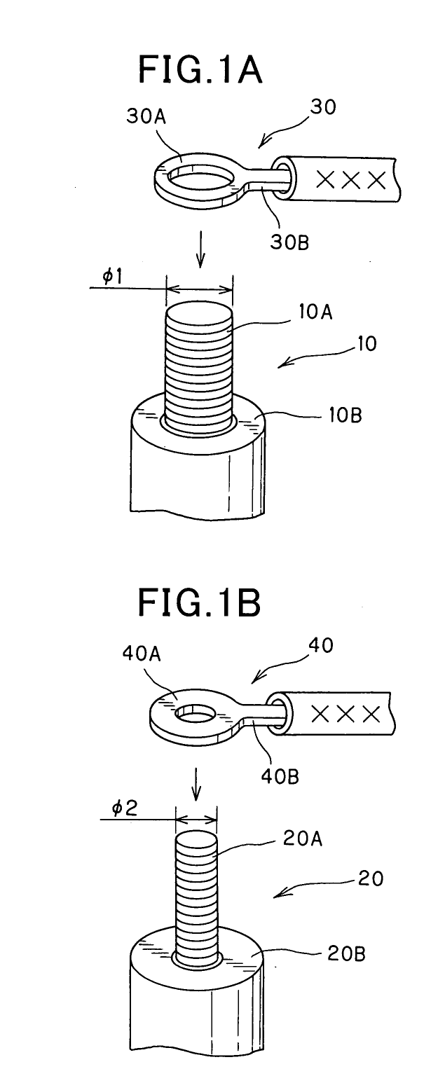

FIGS. 1A and 1B are diagrams showing an output terminal connection structure for a vehicle generator capable of generating high and low voltages according to a first embodiment of the invention. A vehicle generator provided with the output terminal connection structure of this embodiment includes a high voltage output terminal 10 shown in FIG. 1A, and a low voltage output terminal 20 shown in FIG. 1B. The high voltage output terminal 10 includes a lead terminal connecting section 10A formed with external threads at its outer periphery, and a sleeve bearing surface 10B from which the lead terminal connecting section 10A projects. A high voltage lead terminal 30 corresponding to the high voltage output terminal 10 includes a ring section 30A whose inner diameter is slightly larger than the outer diameter of the lead terminal connecting section 10A, and a leader section 30B formed integral with the ring section 30A. By passing the lead terminal connecting section 10A through the ring section 30A, attaching a nut (not shown) to the lead terminal connecting section 10A with one end surface of the ring section 30A being in contact with the bearing surface 10B, and tightening the nut against the other end surface of the ring section 30A, electrical connection between the high voltage output terminal 10 and the high voltage lead terminal 30 is made.

The low voltage output terminal 20 includes a lead terminal connecting section 20A formed with external threads at its outer periphery, and a sleeve bearing surface 20B from which the lead terminal connecting section 20A projects. A low voltage lead terminal 40 corresponding to the low voltage output terminal 20 includes a ring section 40A whose inner diameter is slightly larger than the outer diameter of the lead terminal connecting section 20A, and a leader section 40B formed integral with the ring section 40A. By passing the lead terminal connecting section 20A through the ring section 40A, attaching a nut (not shown) to the lead terminal connecting section 20A with one end surface of the ring section 40A being in contact with the bearing surface 20B, and tightening the nut against the other end surface of the ring section 40A, electrical connection between the low voltage output terminal 20 and the low voltage lead terminal 40 is made.

In this embodiment, the diameter (p1 of the lead terminal connecting section 10A of the high voltage output terminal 10 and the inner diameter of the ring section 30A of the high voltage lead terminal 30 are made smaller than the diameter p2 of the lead terminal connecting section 20A of the low voltage output terminal 20 and the inner diameter of the ring section 40A of the low voltage lead terminal 40. Accordingly, it is possible to prevent the low voltage lead terminal 40 from being connected by mistake to the high voltage output terminal 10, because the ring section 40A having the smaller diameter of the low voltage lead terminal 40 interferes with the lead terminal connecting section 10A having the larger diameter of the high voltage output terminal 10. Accordingly, in accordance with this embodiment, low voltage devices that should be connected to the low voltage output terminal of the generator through the low voltage lead terminal can be prevented from being broken due to shortage of withstand voltage, or short-lived due to excessive temperature rise.

In the above described embodiment, for the purpose of preventing the low voltage lead terminal 40 from being mistakenly connected to the high voltage output terminal 10, the diameters of the low voltage output terminal 20 and the low voltage lead terminal 20 are respectively made smaller than those of the high voltage output terminal 10 and the high voltage lead terminal 10. However, preventing the low voltage lead terminal 40 from being mistakenly connected to the high voltage output terminal 10 is possible also by forming at least one of the high voltage lead terminal 10, the high voltage lead terminal 30, the low voltage lead terminal 20, and the low voltage lead terminal 40 in a such a specific shape or structure that it is physically impossible to connect the low voltage lead terminal 40 to the high voltage output terminal 10.

### Second Embodiment

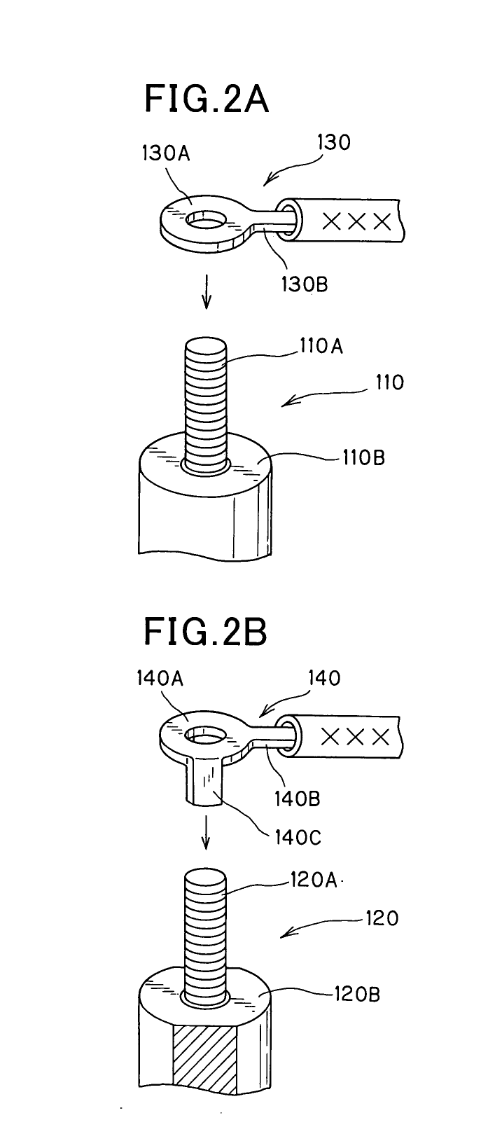

FIGS. 2A and 2B are diagrams showing an output terminal connection structure for a vehicle generator capable of generating high and low voltages according to a second embodiment of the invention. A vehicle generator provided with the output terminal connection structure of this embodiment includes a high voltage output terminal 110 shown in FIG. 2A, and a low voltage output terminal 120 shown in FIG. 2B. The high voltage output terminal 110 includes a lead terminal connecting section 110A formed with external threads at its outer periphery, and a sleeve bearing surface 110B from which the lead terminal connecting section 110A projects. A high voltage lead terminal 130 corresponding to the high voltage output terminal 110 includes a ring section 130A whose inner diameter is slightly larger than the outer diameter of the lead terminal connecting section 110A, and a leader section 130B formed integral with the ring section 130A. By passing the lead terminal connecting section 110A through the ring section 130A, attaching a nut (not shown) to the lead terminal connecting section 110A with one end surface of the ring section 130A being in contact with the bearing surface 110B, and tightening the nut against the other end surface of the ring section 130A, electrical connection between the high voltage output terminal 110 and the high voltage lead terminal 130 is made.

The low voltage output terminal 120 includes a lead terminal connecting section 120A formed with external threads at its outer periphery, and a sleeve bearing surface 120B from which the lead terminal connecting section 120 A projects. A low voltage lead terminal 140 corresponding to the low voltage output terminal 120 includes a ring section 140A whose inner diameter is slightly larger than the outer diameter of the lead terminal connecting section 120A, a leader section 140B formed integral with the ring section 140A, and two projections 140C provided in the ring section 140A so as to project in the direction toward the bearing surface 120B when the ring section 140A is inserted through the lead terminal connecting section 120A. By passing the lead terminal connecting section 120A through the ring section 140A, attaching a nut (not shown) to the lead terminal connecting section 120A with one end surface of the ring section 140A being in contact with the bearing surface 120B, and tightening the nut against the other end surface of the ring section 140A, electrical connection between the low voltage output terminal 120 and the low voltage lead terminal 140 is made.

The high voltage output terminal 110 has such a shape that the projections 140C interfere with the bearing surface 110B thereof when an attempt is made by mistake to connect the low voltage lead terminal 140 to the high voltage output terminal 110. On the other hand, the low voltage output terminal 120 has such a shape that the projections 140C do not interfere with the bearing surface 120B thereof at the time of connecting the low voltage lead terminal 140 to the low voltage output terminal 120.

More specifically, the diameter of the bearing surface 110B of the high voltage output terminal 110 is made larger than the distance between the two projections 140C provided in the ring section 140A of the low voltage lead terminal 140.

On the other hand, the width of at least a part of the bearing surface 120B across its center is slightly smaller than the diameter of the bearing surface 110B of the high voltage output terminal 110 and the distance between the two projections 140C provided in the ring section 140A of the low voltage lead terminal 140. As shown in FIG. 2B, the low voltage output terminal 120 is formed in such a shape that it is cut by two parallel flat planes orthogonal to the bearing surface 120B. The distance between the two planes is slightly smaller than the distance between the two projections 140C. Accordingly, the projections 140C do not interfere with the bearing surface 120B at the time of connecting the low voltage lead terminal 140 to the low voltage output terminal 120.

By use of the low voltage output terminal 120 and the low voltage lead terminal 140 as described above, it becomes possible to prevent, without fail, misconnection between the low voltage lead terminal 140 and the high voltage output terminal 110. Accordingly, in accordance with this embodiment, low voltage devices that should be connected to the low voltage output terminal of the generator through the low voltage lead terminal can be prevented from being broken due to shortage of withstand voltage, or short-lived due to excessive temperature rise.

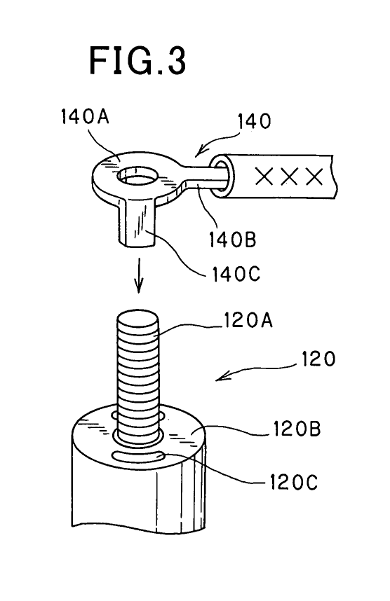

As show in in FIG. 3, for avoiding the two projections 140C from interfering with the bearing surface 120B of the low voltage output terminal 120, the bearing surface 120B may be formed with two recesses 120C for receiving therein the two projections 140C. Also, instead of forming the low voltage output terminal 120 in such a shape that the bearing surface 120B thereof is cut by two parallel flat planes orthogonal to thereto as shown in FIG. 2B, it may be formed to have a polygonal cross section, or it may be formed with concaves in its peripheral surface for receiving therein the projections 140C.

### Third Embodiment

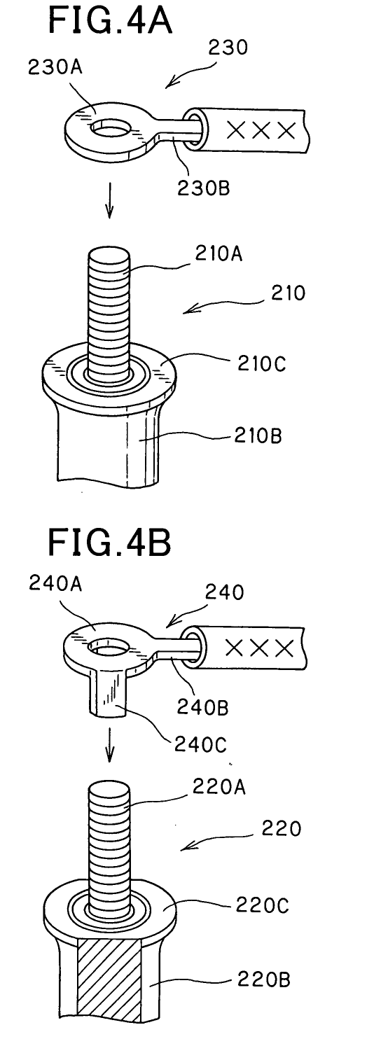

FIGS. 4A and 4B are diagrams showing an output terminal connection structure for a vehicle generator capable of generating high and low voltages according to a third embodiment of the invention. A vehicle generator provided with the output terminal connection structure of this embodiment includes a high voltage output terminal 210 shown in FIG. 4A, and a low voltage output terminal 220 shown in FIG. 4B. The high voltage output terminal 210 includes a lead terminal connecting section 210A formed with external threads at its outer periphery, and a tubular insulating member 210B having a sleeve bearing surface 210C at its top end from which the lead terminal connecting section 210A projects. A high voltage lead terminal 230 corresponding to the high voltage output terminal 210 includes a ring section 230A whose inner diameter is slightly larger than the outer diameter of the lead terminal connecting section 210A, and a leader section 230B formed integral with the ring section 230A. By passing the lead terminal connecting section 210A through the ring section 230A, attaching a nut (not shown) to the lead terminal connecting section 210A with one end surface of the ring section 230A being in contact with a ring-shaped conduction surface provided inside the inner periphery of the bearing surface 210C, and tightening the nut against the other end surface of the ring section 230A, electrical connection between the high voltage output terminal 210 and the high voltage lead terminal 230 is made.

The low voltage output terminal 220 has a lead terminal connecting section 220A formed with external threads at its outer periphery, and a tubular insulating member 220B having a sleeve bearing surface 220C at its top end from which the lead terminal connecting section 220A projects. A low voltage lead terminal 240 corresponding to the low voltage output terminal 220 includes a ring section 240A whose inner diameter is slightly larger than the outer diameter of the lead terminal connecting section 220A, a leader section 240B formed integral with the ring section 240A, and two projections 240C provided in the ring section 240A so as to project in the direction toward the bearing surface 220C when the ring section 240A is inserted through the lead terminal connecting section 220A. By passing the lead terminal connecting section 220A through the ring section 240A, attaching a nut (not shown) to the lead terminal connecting section 220A with one end surface of the ring section 240A being in contact with a ring-shaped conduction surface provided inside the inner periphery of the bearing surface 220C, and tightening the nut against the other end surface of the ring section 240A, electrical connection between the low voltage output terminal 220 and the low voltage lead terminal 240 is made.

The high voltage output terminal 210 has such a shape that the projections 240C interfere with the bearing surface 210C thereof when an attempt is made by mistake to connect the low voltage lead terminal 240 to the high voltage output terminal 210. On the other hand, the low voltage output terminal 220 has such a shape that the projections 240C do not interfere with the bearing surface 220C thereof at the time of connecting the low voltage lead terminal 240 to the low voltage output terminal 220.

More specifically, the diameter of the bearing surface 210C of the high voltage output terminal 210 is made larger than the distance between the two projections 240C provided in the ring section 240A of the low voltage lead terminal 240.

On the other hand, the width of at least a part of the bearing surface 220C across its center is slightly smaller than the diameter of the bearing surface 210C of the high voltage output terminal 210 and the distance between the two projections 240C provided in the ring section 240A of the low voltage lead terminal 240. As shown in FIG. 4B, the low voltage output terminal 220 is formed in such a shape that it is cut by two parallel flat planes orthogonal to the bearing surface 220C. The distance between the two planes is slightly smaller than the distance between the two projections 240C. Accordingly, the projections 240C do not interfere with the bearing surface 220C at the time of connecting the low voltage lead terminal 240 to the low voltage output terminal 220.

By use of the low voltage output terminal 220 and the low voltage lead terminal 240 as described above, it becomes possible to prevent, without fail, misconnection between the low voltage lead terminal and the high voltage output terminal. Accordingly, in accordance with this embodiment, low voltage devices that should be connected to the low voltage output terminal of the generator through the low voltage lead terminal can be prevented from being broken due to shortage of withstand voltage, or short-lived due to excessive temperature rise.

This embodiment also offers the advantage that the drawing direction of the low voltage lead terminal can be fixed by a combination of the projections 240C and the flat planes formed in the low voltage output terminal 220.

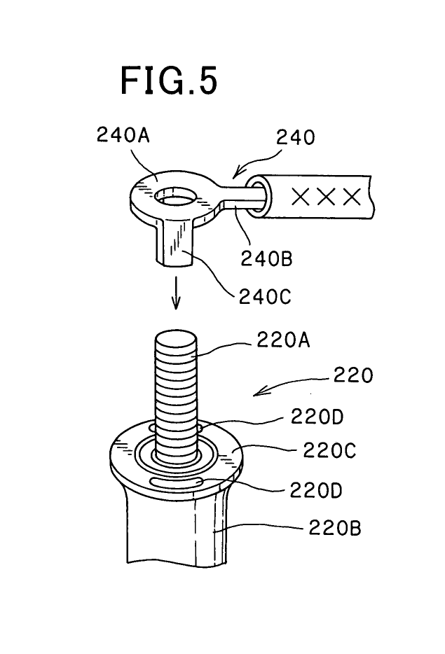

As show in FIG. 5, for avoiding the projections 240C from interfering with the bearing surface 220C of the low voltage output terminal 220, the bearing surface 220C may be formed with two recesses 220D for receiving therein the two projections 240C. Also, instead of forming the low voltage output terminal 220 in such a shape that the bearing surface 220C thereof is cut by two parallel flat planes orthogonal to thereto as shown in FIG. 4B, it may be formed to have a polygonal cross section, or it may be formed with concaves in its peripheral surface for receiving therein the projections 240C.

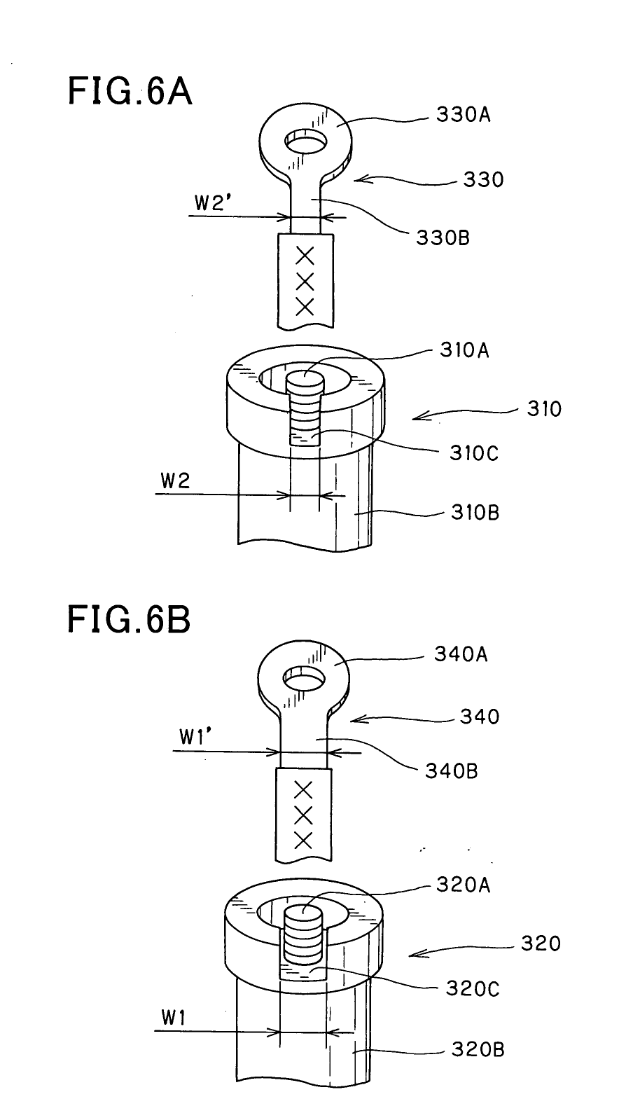

FIGS. 6A and 6B are diagrams showing an output terminal connection structure for a vehicle generator capable of generating high and low voltages according to a fourth embodiment of the invention. A vehicle generator provided with the output terminal connection structure of this embodiment includes a high voltage output terminal 310 shown in FIG. 6A, and a low voltage output terminal 320 shown in FIG. 6B. The high voltage output terminal 310 includes a lead terminal connecting section 310A formed with external threads at its outer periphery, and an insulating member 310B surrounding the lead terminal connecting section 310A. The insulating member 310B has a tubular shape so as to surround the whole of the peripheral surface of the lead terminal connecting section 310A, and is formed with a turn-prevention recess 310C at its circumferential end. A high voltage lead terminal 330 corresponding to the high voltage output terminal 310 includes a ring section 330A whose inner diameter is slightly larger than the outer diameter of the lead terminal connecting section 310A, and a leader section 330B formed integral with the ring section 330A. Bypassing the lead terminal connecting section 310A through the ring section 330A with the leader section 330B being put in the recess 310C, attaching a nut (not shown) to the lead terminal connecting section 310A, and tightening the nut against the ring section 330A, electrical connection between the high voltage output terminal 310 and the high voltage lead terminal 330 is made.

The low voltage output terminal 320 includes a lead terminal connecting section 320A formed with external threads at its outer periphery, and an insulating member 320B surrounding the lead terminal connecting section 320A. The insulating member 320B has a tubular shape so as to surround the whole of the peripheral surface of the lead terminal connecting section 320A, and is formed with a turn-prevention recess 320C at its circumferential end. A low voltage lead terminal 340 corresponding to the low voltage output terminal 320 has a ring section 340A whose inner diameter is slightly larger than the outer diameter of the lead terminal connecting section 320A, and a leader section 340B formed integral with the ring section 340A. By passing the lead terminal connecting section 320A through the ring section 340A with the leader section 340B being put in the recess 320C, attaching a nut (not shown) through the lead terminal connecting section 320A, and tightening the nut against the ring section 340A, electrical connection between the low voltage output terminal 320 and the low voltage lead terminal 340 is made.

The circumferential width W2 of the recess 310C and the width W2′ of the leader section 330B of the high voltage lead terminal 330 are made respectively smaller than the circumferential width W1 of the recess 320C and the width W1′ of the leader section 340B of the low voltage lead terminal 340. Accordingly, when an attempt is made by mistake to connect the low voltage lead terminal 340 to the high voltage output terminal 310, the leader section 340B of the low voltage lead terminal 340 interferes with the insulating member 310B, while on the other hand, the leader section 340B does not interfere with the insulating member 320B at the time of connecting the low voltage lead terminal 340 to the low voltage output terminal 320.

By use of the low voltage output terminal 320, insulating member 320B, low voltage lead terminal 340, and the insulating member 340B as described above, it becomes possible to prevent, without fail, misconnection between the low voltage lead terminal and the high voltage output terminal. Accordingly, in accordance with this embodiment, low voltage devices that should be connected to the low voltage output terminal of the generator through the low voltage lead terminal can be prevented from being broken due to shortage of withstand voltage, or short-lived due to excessive temperature rise.

Although the output terminals of the above described embodiments have a bolt screw having a circular cross section as the terminal connecting section, it may be a metal stem having a polygonal cross section. In this case, by making a difference in shape of a polygonal hole or a notch hole formed in the corresponding lead terminal between the high and low voltage lead terminals, it is possible to prevent the low voltage lead terminal from being connected by mistake to the high voltage output terminal.

The bearing surface 110B of the high voltage output terminal 110 and the bearing surface 210C of the insulating member 210B does not necessary have to be formed in a complete circular shape. They may be formed with a notch at its periphery as far as they have a shape interfering with the projections provided in the low voltage lead terminal. In this case by providing projections also in the ring section of the high voltage lead terminal, it becomes possible to fix the drawing direction of the high voltage lead terminal, while preventing the low voltage output terminal from being connected by mistake to the high voltage output terminal.

The above explained preferred embodiments are exemplary of the invention of the present application which is described solely by the claims appended below. It should be understood that modifications of the preferred embodiments may be made as would occur to one of skill in the art.

What is claimed is:

1. An output terminal connection structure for a vehicle generator capable of generating a high voltage and a low voltage comprising:
a high voltage output terminal provided in said vehicle generator;
a high voltage lead terminal to be connected to said high voltage output terminal;
a low voltage output terminal provided in said vehicle generator; and
a low voltage lead terminal to be connected to said low voltage output terminal;
wherein at least one of said high voltage output terminal, said high voltage lead terminal, said low voltage output terminal, and said low voltage lead terminal is formed in such a shape or a structure that said low voltage lead terminal can be prevented from being connected to said high voltage output terminal.

2. The output terminal connection structure according to claim 1, wherein said low voltage output terminal, and said low voltage lead terminal are respectively smaller in outer dimension than said high voltage output terminal, and said high voltage lead terminal.

3. The output terminal connection structure according to claim 1, wherein said low voltage terminal is provided with a projection, said projection interfering with a bearing surface of said high voltage output terminal provided for bearing said high voltage lead terminal, to thereby prevent misconnection between said low voltage lead terminal and said high voltage output terminal, and not interfering with a bearing surface of said low voltage output terminal provided for bearing said low voltage lead terminal to allow connection between said low voltage lead terminal and said low voltage output terminal.

4. The output terminal connection structure according to claim 3, wherein a smallest width of said bearing surface of said low voltage output terminal across a center thereof is smaller than a smallest width of said bearing surface of said high voltage output terminal across a center thereof.

5. The output terminal connection structure according to claim 3, wherein said bearing surface of said low voltage output terminal is formed with a recess receiving therein said projection when said low voltage lead terminal is connected to said low voltage output terminal.

6. The output terminal connection structure according to claim 1, wherein said low voltage lead terminal is provided with a projection, said high voltage output terminal being partially covered by an insulating member having a bearing surface for bearing said high voltage lead terminal, and said low voltage output terminal being partially covered by an insulating member having a bearing surface for bearing said low voltage lead terminal, said projection interfering with said bearing surface of said high voltage output terminal, to thereby prevent misconnection between said low voltage lead terminal and said high voltage output terminal, and not interfering with said bearing surface of said low voltage output terminal to allow connection between said low voltage lead terminal and said low voltage output terminal.

7. The output terminal connection structure according to claim 6, wherein a smallest width of said bearing surface of said low voltage output terminal across a center thereof is smaller than a smallest width of said bearing surface of said high voltage output terminal across a center thereof.

8. The output terminal connection structure according to claim 6, wherein said bearing surface of said low voltage output terminal is formed with a recess receiving therein said projection when said low voltage lead terminal is connected to said low voltage output terminal.

9. The output terminal connection structure according to claim 1, wherein said high voltage output terminal is partially covered by a tubular insulating member which is formed with a first turn-prevention recess at a circumferential end thereof allowing a part of said high voltage lead terminal to be housed therein when said high voltage lead terminal is connected to said high voltage output terminal, and said low voltage output terminal is partially covered by a tubular insulating member which is formed with a second turn-prevention recess at a circumferential end thereof allowing a part of said low voltage lead terminal to be housed therein when said low voltage lead terminal is connected to said low voltage output terminal, a circumferential width of said first turn-prevention recess and a width of said part of said high voltage lead terminal being smaller than a circumferential width of said second turn-prevention recess and a width of said part of said low voltage lead terminal.
